(19) United States
(12) Patent Application Publication
(10) Pub. No.: US 2005/0180303 A1
(43) Pub. Date: Aug. 18, 2005

(54) Optical recording medium

(75) Inventors: Hiroshi Shingai, Tokyo (JP); Hideki Hirata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 11/037,106

(22) Filed: Jan. 19, 2005

(30) Foreign Application Priority Data
Jan. 21, 2004 (JP) 2004-012149

(51) Int. Cl. G11B 7/24

(52) U.S. Cl. 369/275.2; 369/288

(57) ABSTRACT

An optical recording medium including a recording layer 23 having a phase transition material and a light transmitting layer 13 on a substrate 11, a laser beam being irradiated on the recording layer 23 through the light transmitting layer 13 so that data can be recorded and recorded data can be erased, wherein at least three dielectric layers 24, 25 and 26 containing, as main components, different dielectric materials from each other are formed between the recording layer 23 and the light transmitting layer 13.

### BACKGROUND OF THE INVENTION

The present invention relates to a rewritable optical recording medium, and more particularly to an optical recording medium capable of effectively radiating a heat generated on a recording layer and recording data as desired.

Conventionally, an optical recording medium represented by a recordable CD or a recordable DVD has been utilized widely as a recording medium for recording digital data.

These optical recording media can be classified roughly into a write-once optical recording medium which can add data but cannot rewrite data, for example, a CD-R or a DVD-R, and a rewritable optical recording medium capable of rewriting data, for example, a CD-RW or a DVD-RW.

In the rewritable optical recording medium of these optical recording media, a phase transition material is used as a material for a recording layer, and data are recorded by utilizing a difference between a reflectance obtained when the phase transition material is set in a crystalline state and a reflectance obtained when it is set in an amorphous state.

For example, the whole surface of the recording layer is set in the crystalline state in a situation in which data are not recorded, and the recording layer is locally changed into the amorphous state so that a recording mark is formed when the data are recorded.

When the recording mark is to be formed to record data on the recording layer of an optical recording medium, a laser beam having a power modulated in accordance with the recording mark to be formed is irradiated on the recording layer.

More specifically, as an example, when data are to be recorded on the recording layer of the optical recording medium, a laser beam having a power modulated between a recording power Pw and a base power Pb is irradiated on the predetermined region of the recording layer so that the predetermined region of the recording layer is heated to a melting point or more and is then quenched, and an amorphous region is formed and a recording mark is thus formed.

On the other hand, when the data recorded on the recording layer of the optical recording medium are to be erased, a laser beam set to have an erase power Pe is irradiated on a region on which the recording mark of the recording layer is formed so that the region of the recording layer on which the laser beam is irradiated is heated to have a temperature which is equal to or higher than a crystallizing temperature and is then cooled slowly, and the amorphous region is thus crystallized and the recording mark is erased.

In recent years, a next generation optical recording medium having a larger capacity and a higher data transfer rate has vigorously been developed. Also in a rewritable optical recording medium, similarly, a storage capacity has been increased.

In such an optical recording medium, a wavelength λ of a laser beam is decreased and a numerical aperture NA of an objective lens is increased to reduce the beam spot diameter of the laser beam. Consequently, the recording density of data can be enhanced and a recording capacity can be increased. In the case in which the wavelength λ of the laser beam is decreased and the numerical aperture NA of the objective lens is increased, however, an angle error permitted for the inclination of the optical axis of the laser beam for the optical recording medium, that is, a tilt margin is reduced very greatly. For this reason, a light transmitting layer having a thickness of approximately 100 μm is provided on the opposite side of a substrate and a laser beam is irradiated from the light transmitting layer side to record and reproduce data, thereby enlarging the tilt margin.

In the optical recording medium, however, the beam spot diameter of the laser beam is reduced. Therefore, an energy density in the beam spot is increased so that the recording layer is locally heated to a very high temperature. Thus, a heat generated on the recording layer is also transferred to the light transmitting layer including, as a main component, an ultraviolet curing resin having a low thermal resistance. For this reason, there is a possibility that the light transmitting layer might be broken. Consequently, there is a problem in that the reliability of the optical recording medium is lowered.

In order to enhance the reliability of the optical recording medium, accordingly, it is necessary to employ a structure for preventing the heat generated on the recording layer from being transmitted to the light transmitting layer. There has been known a rewritable optical recording medium having a structure which has been described in JP-A-2003-006930.

In the rewritable optical recording medium described in JP-A-2003-006930, a radiating layer containing, as a main component, a nitride or an oxide containing an element selected from the group consisting of B, Al, Ga, In, C, Si, Ge and Sn or their mixture is formed between a recording layer and a light transmitting layer. Such a radiating layer has a high thermal conductivity. Even if the recording layer is locally heated to a very high temperature, a heat generated on the recording layer can be diffused before the heat is transferred to the light transmitting layer.

As described above, in order to enhance the reliability of an optical recording medium, it is effective that a radiating layer having a high thermal conductivity is formed between the recording layer and the light transmitting layer. However, such a radiating layer has a problem in that an adhesion to the recording layer containing a phase transition material is poor. In the rewritable optical recording medium comprising the radiating layer, accordingly, it is necessary to form a dielectric layer containing a mixture of ZnS and SiO₂ as a main component between the recording layer and the radiating layer. More specifically, since the dielectric layer containing the mixture of ZnS and SiO₂ as the main component has a lower hardness than the recording layer and the radiating layer, it has a high adhesion to both the recording layer and the radiating layer. Therefore, the dielectric layer containing the mixture of ZnS and SiO₂ as the main component is formed between the recording layer and the radiating layer so that the mutual adhesion to the recording layer, the dielectric layer and the radiating layer can be enhanced.

In the case in which the dielectric layer containing the mixture of ZnS and SiO₂ as the main component is formed adjacently to the recording layer containing the phase transition material, however, there is a problem in that the crystallizing speed of the recording layer is reduced and data cannot be rewritten as desired if the data recorded on the recording layer are rewritten many times. More specifically, when the data recorded on the recording layer are rewritten many times, the phase transition material contained in the recording layer is repetitively molten. At this time, sulfur contained in the dielectric layer is mixed from an interface between the recording layer and the dielectric layer into the recording layer. As a result, there is caused a situation in which the property of the recording layer is changed to reduce the crystallizing speed.

In recent years, moreover, there has also been developed an optical recording medium having a structure in which at least two recording layers are provided through an intermediate layer in order to further increase a recording capacity.

In an optical recording medium in which at least two recording layers are provided, a laser beam is irradiated through a recording layer on a close side to a light incidence plane when data are to be recorded on a recording layer which is distant from the light incidence plane and the recorded data are to be reproduced. For this reason, the recording layer on the close side to the light incidence plane is to have a high light transmittance and the thickness of the recording layer is to be reduced.

When the thickness of the recording layer is reduced, however, the content ratio of the phase transition material contained in the recording layer to the sulfur contained in the dielectric layer is relatively reduced. For this reason, the recording layer is easily influenced by the sulfur. Consequently, it is much harder to prevent the crystallizing speed of the recording layer from being decreased.

### SUMMARY OF THE INVENTION

Accordingly, it is an object of the invention to provide an optical recording medium capable of effectively radiating a heat generated on a recording layer and recording data as desired.

The object of the invention can be attained by an optical recording medium comprising a recording layer including a phase transition material and a light transmitting layer on a substrate, a laser beam being irradiated on the recording layer through the light transmitting layer so that data can be recorded and recorded data can be erased, wherein at least three dielectric layers containing, as main components, different dielectric materials from each other are formed between the recording layer and the light transmitting layer.

In this specification, the containment of an element as a main component implies that the content of the same element in elements contained in a certain layer is the greatest.

In the optical recording medium, in order to record data as desired, it is necessary to carry out a proper radiation processing over the optical recording medium in such a manner that a heat generated on the recording layer does not influence other layers when the data are recorded. In the case in which another layer is to be formed in the vicinity of the recording layer, moreover, it is necessary to take a compatibility with the recording layer into consideration in order not to hinder the recording characteristic of the recording layer. In order to enhance the reliability of the optical recording medium, furthermore, it is also necessary to mutually increase the adhesion of each layer. For this reason, various conditions such as a radiating characteristic, a compatibility with the recording layer and an adhesion are required for a layer to be formed between the recording layer and the light transmitting layer, and it is hard to satisfy all of these conditions.

In the invention, however, at least three dielectric layers containing, as main components, different dielectric materials from each other are formed between the recording layer and the light transmitting layer, and a proper one of the dielectric materials can be selected to form each of the dielectric layers corresponding to the radiating characteristic, the compatibility with the recording layer and the adhesion which are required. Consequently, it is possible to satisfy various conditions set to the layer to be formed between the recording layer and the light transmitting layer. According to the invention, accordingly, the heat generated on the recording layer can be radiated effectively, and furthermore, the data can be recorded as desired.

### BRIEF DESCRIPTION OF THE DRAWINGS

FIG. 1 is a schematic sectional view showing an optical recording medium according to a preferred embodiment of the invention,

FIG. 2 is a schematic enlarged sectional view showing a portion indicated as A in FIG. 1,

FIG. 3 is a schematic enlarged view showing an optical recording medium according to another preferred embodiment of the invention, and

FIG. 4 is a schematic enlarged sectional view showing a portion indicated as B in FIG. 3.

### DETAILED DESCRIPTION OF THE PREFERRED EMBODIMENTS

In a preferable mode of the invention, a first dielectric layer, a second dielectric layer and a third dielectric layer are provided in order from an incidence plane side for the laser beam between the recording layer and the light transmitting layer, the first dielectric layer has a higher thermal conductivity than the second dielectric layer, the second dielectric layer has a lower hardness than the first dielectric layer and the third dielectric layer, and the third dielectric layer includes, as a main component, a dielectric material which does not substantially contain sulfur.

In the invention, the first dielectric layer has a higher thermal conductivity than the second dielectric layer and functions as a radiating layer for radiating a heat generated on the recording layer. For this reason, even if the recording layer is locally heated to a very high temperature, the heat generated on the recording layer can be diffused effectively before the heat is transferred to the light transmitting layer. According to the invention, therefore, it is possible to prevent the light transmitting layer from being heated to a high temperature and to enhance the reliability of the optical recording medium.

In the invention, moreover, the second dielectric layer has a lower hardness than the first dielectric layer and the third dielectric layer. According to the invention, therefore, it is possible to enhance the mutual adhesion of the first dielectric layer, the second dielectric layer and the third dielectric layer.

In the invention, furthermore, the third dielectric layer contains, as a main component, a dielectric material which does not substantially contain sulfur.

In this specification, the substantial non-containment of the sulfur implies that the sulfur is not contained in the third dielectric layer except that the sulfur is contained as an impurity.

When the data recorded on the recording layer are rewritten many times, there is a possibility that the crystallizing speed of the recording layer might be reduced and the data recorded on the recording layer might not be rewritten as desired. In the invention, however, the third dielectric layer formed in the vicinity of the recording layer does not substantially contain sulfur. Even if a phase transition material contained in the recording layer is molten many times, therefore, the property of the recording layer is prevented from being changed by the influence of an element contained in the third dielectric layer. Consequently, it is possible to reliably prevent the crystallizing speed of the recording layer from being reduced. According to the invention, therefore, it is possible to repetitively rewrite the data recorded on the recording layer as desired.

In a more preferable mode of the invention, the first dielectric layer includes, as a main component, a nitride or an oxide containing an element selected from the group consisting of B, Al, Ga, In, C, Si, Ge, Be, Zn and Sn or their mixture.

In a further preferable mode of the invention, the third dielectric layer includes, as a main component, an oxide containing at least one of metals of Zr and Mg. In the case in which the third dielectric layer includes, as the main component, the oxide containing at least one of the metals of Zr and Mg, a heat generated on the recording layer can be diffused to the first dielectric layer side more effectively.

There is not always apparent the reason why the heat generated on the recording layer can be diffused to the first dielectric layer side more effectively in the case in which the third dielectric layer includes, as the main component, the oxide containing at least one of the metals of Zr and Mg. However, it can be guessed that the thermal conductivity of the third dielectric layer is enhanced by the formation of the third dielectric layer to include, as the main component, the oxide containing at least one of the metals of Zr and Mg.

In a further preferable mode of the invention, the third dielectric layer contains zirconium oxide as a main component and has a cubic crystallinity.

In such a case, the heat generated on the recording layer can be diffused to the first dielectric layer side more effectively. While the zirconium oxide has been known as a material having a low thermal conductivity, generally, the zirconium oxide is formed to have a cubic crystallinity in the invention. For this reason, it can be supposed that the thermal conductivity of the third dielectric layer can be enhanced.

In the invention, in the case in which the third dielectric layer contains the zirconium oxide as the main component and has a cubic crystallinity, it is more preferable that each crystal should have a crystal grain size of 20 nm or less.

In a further preferable mode of the invention, a reflecting layer is further formed in the vicinity of the recording layer and the dielectric layer including, as a main component, an oxide containing at least one of metals of Zr and Mg is formed between the recording layer and the reflecting layer.

According to the invention, it is possible to record data by forming a recording mark on the recording layer as desired. There is not always apparent the reason why it is possible to record the data by forming the recording mark on the recording layer as desired in the case in which the reflecting layer is further provided and the dielectric layer including, as the main component, the oxide containing at least one of the metals of Zr and Mg is formed between the recording layer and the reflecting layer. However, it can be guessed that the thermal conductivity of the dielectric layer formed between the recording layer and the reflecting layer is enhanced so that the heat generated on the recording layer can be effectively diffused to the reflecting layer side, resulting in an increase in a cooling efficiency.

In the invention, it is preferable that the reflecting layer should contain a metal as a main component.

The reflecting layer can be formed by Mg, Al, Ti, Cr, Fe, Co, Ni, Cu, Zn, Ge, Ag, Pt or Au, and a metal material such as an alloy containing at least one of the metals, for example, Al, Au, Ag or Cu which has a high reflectance or an alloy of Ag and Cu is preferably used in order to form the reflecting layer. In the case in which the reflecting layer contains Ag, particularly, the reflecting layer can be formed in such a manner that a surface thereof has an excellent flatness. It is possible to minimize the noise level of a reproducing signal when data recorded on the recording layer are to be reproduced.

On the other hand, however, Ag has a high reactivity to the sulfur. When a layer containing the sulfur is formed in the vicinity of the reflecting layer, therefore, there is a new problem in that Ag contained in the reflecting layer reacts to the sulfur contained in the layer formed in the vicinity of the reflecting layer so that the surface of the reflecting layer is corroded. In the invention, however, the dielectric layer formed in the vicinity of the reflecting layer includes, as the main component, the oxide containing at least one of the metals of Zr and Mg and does not substantially contain the sulfur. Consequently, it is possible to avoid the corrosion of the surface of the reflecting layer. Thus, it is possible to maintain a high storage reliability.

As a further preferable mode of the invention, a laser beam having a wavelenght λ of 380 nm to 450 nm is irradiated thought an objective lens having a numerical aperture NA of 0.7 to 0.9 so that data can be recorded and recorded data can be erased.

The object of the invention can also be attained by an optical recording medium comprising, on a substrate, a plurality of recording layers including a phase transition material and provided through at least an intermediate layer and a light transmitting layer, a laser beam being irradiated on the recording layers through the light transmitting layer so that data can be recorded and recorded data can be erased, wherein at least three dielectric layers containing, as main components, different dielectric materials from each other are formed between at least one of the recording layers and the light transmitting layer or between at least one of the recording layers and the intermediate layer.

In the invention, a first dielectric layer, a second dielectric layer and a third dielectric layer are provided in order from the incidence plane side for the laser beam between at least one of the recording layers and the light transmitting layer or between at least one of the recording layers and the intermediate layer, and the first dielectric layer has a higher thermal conductivity than the second dielectric layer and the second dielectric layer has a lower hardness than the first dielectric layer and the third dielectric layer, and the third dielectric layer includes, as a main component, a dielectric material which does not substantially contain sulfur.

According to the invention, it is possible to provide an optical recording medium capable of effectively radiating a heat generated on a recording layer and recording data as desired.

Preferred embodiments of the invention will be described below in detail with reference to the accompanying drawings.

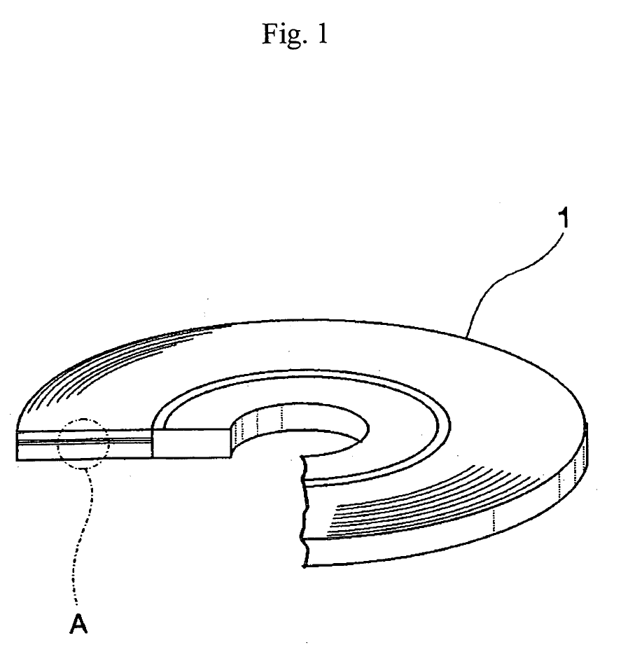

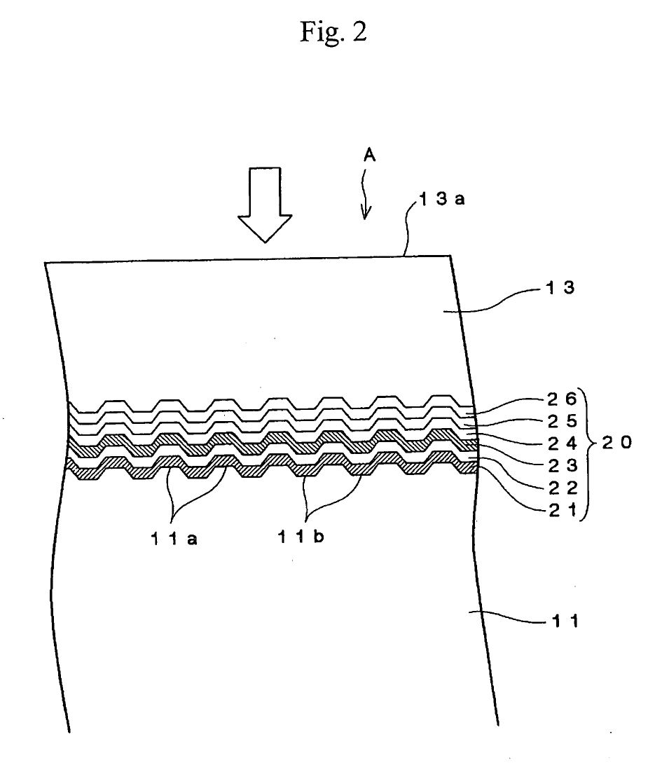

FIG. 1 is a schematic perspective view showing an optical recording medium according to a preferred embodiment of the invention, and FIG. 2 is a schematic enlarged sectional view showing a portion indicated as A in FIG. 1.

As shown in FIG. 1, an optical recording medium 1 according to the embodiment is disc-shaped and has such a structure that a laser beam is irradiated in a direction shown in an arrow in FIG. 2.

As shown in FIG. 2, the optical recording medium 1 according to the embodiment comprises a support substrate 11, an information layer 20 formed on the support substrate 11, and a light transmitting layer 13 formed on the information layer 20.

The support substrate 11 functions as a mechanical support for the optical recording medium 1.

If a material for forming the support substrate 11 can function as a support for the optical recording medium 1, it is not particularly restricted but can be formed by glass, ceramic or a resin, for example. In respect of the easiness of formation, the resin is preferably used. Examples of such a resin include a polycarbonate resin, an olefin resin, an acryl resin, an epoxy resin, a polystyrene resin, a polyethylene resin, a polypropylene resin, a silicone resin, a fluorine type resin, an ABS resin and an urethane resin. In respect of a workability and an optical characteristic, the polycarbonate resin and the olefin resin are particularly preferable. In the embodiment, the support substrate 11 is formed by the polycarbonate resin.

In the embodiment, the support substrate 11 has a thickness of approximately 1.1 mm.

In the embodiment, a laser beam is irradiated through the light transmitting layer 13 positioned on the opposite side of the support substrate 11. For this reason, the support substrate 11 does not need to always have a light transmitting property.

A groove 11a and a land 11b are formed alternately on the surface of the support substrate 11. The groove 11a and/or the land 11b formed on the surface of the support substrate 11 function(s) as a guide track for a laser beam in the case in which the data are to be recorded on the information layer 20 and the case in which the data are to be reproduced from the information layer 20. It is preferable that the depth of the groove 11a should be set to be λ/(18n) or λ/(4n) (λ represents a wavelenght of the laser beam and n represents a refractive index of the light transmitting layer 13), and the pitch of the groove 11a should be set to be about 0.2 μm to 0.4 μm.

As shown in FIG. 2, the information layer 20 includes a reflecting layer 21 formed on the support substrate 11, a fourth dielectric layer 22 formed on the reflecting layer 21, a recording layer 23 formed on the fourth dielectric layer 22, a third dielectric layer 24 formed on the recording layer 23, a second dielectric layer 25 formed on the third dielectric layer 24, and a first dielectric layer 26 formed on the second dielectric layer 25, and the first dielectric layer 26, the second dielectric layer 25 and the third dielectric layer 24 contain, as main components, different dielectric materials from each other.

The reflecting layer 21 reflects a laser beam irradiated on the recording layer 23 through the light transmitting layer 13, and plays a part in an emission from the light transmitting layer 13 again, and furthermore, plays a part in the effective radiation of a heat generated on the recording layer 23 by the irradiation of the laser beam.

The reflecting layer 21 contains a metal as a main component. In this specification, the containment of an element as a main component implies that the content ratio of the same element contained in a certain layer is the highest.

The reflecting layer 21 can be formed by Mg, Al, Ti, Cr, Fe, Co, Ni, Cu, Zn, Ge, Ag, Pt or Au. A metal material such as an alloy containing at least one of metals Al, Au, Ag and Cu which have a high reflectance and an alloy of Ag and Cu is preferably used in order to form the reflecting layer 21. In the case in which the reflecting layer 21 contains Ag, particularly, the reflecting layer 21 can be formed in such a manner that a surface thereof has an excellent flatness, and it is possible to reduce the noise level of a reproducing signal when the data recorded on the recording layer 23 are to be reproduced.

The thickness of the reflecting layer 21 is not particularly restricted but is preferably 10 nm to 300 nm and is particularly preferably 20 nm to 200 nm. If the thickness of the reflecting layer 21 is smaller than 10 nm, it is hard to sufficiently increase the reflectance of the reflecting layer 21 and it is difficult to radiate the heat generated on the recording layer 23. On the other hand, if the thickness of the reflecting layer 21 exceeds 200 nm, a long time is required for forming the reflecting layer 21. Consequently, there is a possibility that a productivity might be reduced and a crack might be generated by an internal stress.

The fourth dielectric layer 22 and the third dielectric layer 24 have the function of protecting the recording layer 23 physically and chemically and controlling the diffusion of a heat from the recording layer 23 to the reflecting layer 21 and the first dielectric layer 26, and furthermore, regulating an optical characteristic for reproducing the data recorded on the recording layer 23.

In the embodiment, the fourth dielectric layer 22 and the third dielectric layer 24 have high thermal conductivities and contain, as main components, dielectric materials which do not substantially contain sulfur. More specifically, the fourth dielectric layer 22 and the third dielectric layer 24 are formed to contain zirconium oxide as a main component. Moreover, the fourth dielectric layer 22 and the third dielectric layer 24 have a cubic crystallinity, and furthermore, is formed in such a manner that the crystal grain size of each crystal is equal to or smaller than 20 nm.

In this specification, the substantial non-containment of the sulfur implies that the fourth dielectric layer 22 and the third dielectric layer 24 do not contain the sulfur except that the sulfur is contained as an impurity.

The fourth dielectric layer 22 and the third dielectric layer 24 can be formed by vapor phase growth using chemical species containing the constitutional elements of the fourth dielectric layer 22 and the third dielectric layer 24, for example. Examples of the vapor phase growth include vacuum evaporation and sputtering.

It is preferable that both of the thicknesses of the fourth dielectric layer 22 and the third dielectric layer 24 should be 3 nm to 15 nm. In the case in which the thicknesses of the fourth dielectric layer 22 and the third dielectric layer 24 are smaller than 3 nm, it is hard to form the fourth dielectric layer 22 and the third dielectric layer 24 as continuous layers. In the case in which the same thicknesses are greater than 15 nm, an internal stress generated in the formation of the fourth dielectric layer 22 and the third dielectric layer 24 is increased so that a crack is easily generated.

The recording layer 23 is a layer on which data are to be recorded. The recording layer 23 is formed to contain a phase transition material. By utilizing a difference between a reflectance obtained when the phase transition material is set in a crystalline state and a reflectance obtained when it is set in an amorphous state, data are recorded on the recording layer 23 and the data are reproduced from the recording layer 23.

The phase transition material for forming the recording layer 23 is not particularly restricted but it is preferable that the recording layer 23 should be formed to include a phase transition material containing at least one element selected from the group consisting of Sb, Te, Ge, Tb and Mn.

When the recording layer 23 includes the phase transition material containing Sb, Te, Ge and Tb, it is preferable that the content of Sb is 65 to 90 atomic %, the content of Te should be 0 to 20 atomic %, the content of Ge should be 2 to 20 atomic %, and the content of Tb should be 2 to 15 atomic %. When the recording layer 23 includes a phase transition material containing Sb, Te, Ge and Mn, it is preferable that the recording layer 23 should be formed in the same manner that it includes the phase transition material containing Sb, Te, Ge and Tb except that the content of Mn should be 2 to 15 atomic%.

The recording layer 23 can be formed by vapor phase growth using chemical species containing the constitutional element of the recording layer 23, for example. Examples of the vapor phase growth include vacuum evaporation and sputtering.

The recording layer 23 is preferably formed to have a thickness of 2 nm to 40 nm, is more preferably formed to have a thickness of 4 nm to 30 nm, and is further preferably formed to have a thickness of 5 nm to 20 nm.

When the thickness of the recording layer 23 is smaller than 2 nm, a difference in an optical characteristic made before and after recording is reduced and a reproducing signal having a high C/N ratio cannot be obtained when data are reproduced. On the other hand, when the thickness of the recording layer 23 is greater than 40 nm, a necessary heat capacity for recording data is increased so that a recording sensitivity is deteriorated and a recording mark is formed with difficulty.

The second dielectric layer 25 functions as a buffer layer for enhancing an adhesion to the third dielectric layer 24 and the first dielectric layer 26 which will be described below.

The second dielectric layer 25 contains, as a main component, a dielectric material having a lower hardness than the third dielectric layer 24 and the first dielectric layer 26 and a high adhesion to both the third dielectric layer 24 and the first dielectric layer 26.

A material for forming the second dielectric layer 25 has a high light transmitting property, and a material having a high adhesion to the third dielectric layer 24 and the first dielectric layer 26 is not particularly restricted. In the embodiment, the second dielectric layer 25 contains a mixture of ZnS and SiO₂ as a main component.

In the case in which the second dielectric layer 25 contains the mixture of ZnS and SiO₂ as the main component, it is preferable that a mole ratio of ZnS to SiO₂ should be 80:20. If the mole ratio of ZnS is lower than 80%, there is a possibility that the refractive index of the second dielectric layer 25 might be decreased and a difference in a reflectance between a region in which a recording mark is formed and a region in which the recording mark is not formed might be reduced.

The second dielectric layer 25 can be formed by vapor phase growth using chemical species containing the constitutional element of the second dielectric layer 25, for example. Examples of the vapor phase growth include vacuum evaporation and sputtering.

It is preferable that the thickness of the second dielectric layer 25 should be 5 nm to 20 nm. In the case in which the thickness of the second dielectric layer 25 is smaller than 5 nm, a crack is easily generated on the second dielectric layer 25. In the case in which the same thickness is greater than 20 nm, there is a possibility that a radiating effect might be deteriorated.

The first dielectric layer 26 functions as a radiating layer for radiating a heat transferred from the recording layer 23 through the third dielectric layer 24 and the second dielectric layer 25.

In order to effectively radiate the heat generated on the recording layer 23, the first dielectric layer 26 contains, as a main component, a dielectric material having a higher thermal conductivity and a higher light transmitting property than the second dielectric layer 25. More specifically, it is preferable that the first dielectric layer 26 should be formed by a nitride or an oxide containing an element selected from the group consisting of B, Al, Ga, In, C, Si, Ge, Be, Zn and Sn, or their mixture.

The first dielectric layer 26 can be formed by vapor phase growth using chemical species containing the constitutional element of the first dielectric layer 26, for example. Examples of the vapor phase growth include vacuum evaporation and sputtering.

It is preferable that the first dielectric layer 26 should be formed to have a thickness of 20 nm to 70 nm. In the case in which the thickness of the first dielectric layer 26 is smaller than 20 nm, a sufficient radiating effect cannot be obtained. In the case in which the same thickness is greater than 70 nm, there is a possibility that a time required for forming a film might be prolonged and a productivity might be deteriorated.

The light transmitting layer 13 is a layer for transmitting a laser beam, and a light incidence plane 13a is constituted by one of surfaces thereof

If a material for forming the light transmitting layer 13 has a high light transmitting property for a laser beam, it is not particularly restricted but it is preferable that an ultraviolet curing resin such as an acryl type resin or an epoxy type resin should be used.

The light transmitting layer 13 can be formed by spin coating using an ultraviolet curing resin or bonding, with an adhesive, a sheet formed by a light transmitting resin.

The light transmitting layer 13 is preferably formed to have a thickness of 10 μm to 300 μm, and is more preferably formed to have a thickness of 50 μm to 150 μm.

Data are recorded on the optical recording medium 1 having the above structure in the following manner.

In the embodiment, in order to record data on the optical recording medium 1, a laser beam having a wavelength λ of 380 nm to 450 nm through the light incidence plane 13a of the light transmitting layer 13 is irradiated through an objective lens having a numerical aperture NA of 0.7 to 0.9.

In order to record data on the recording layer 23, a laser beam having a power modulated is focused on the recording layer 23 and is irradiated on the recording layer 23 through the light transmitting layer 13 among a recording power Pw, an erase power Pe and a base power Pb. The recording power Pw, the base power Pb and the erase power Pe of the laser beam satisfy a relationship of Pw>Pe>Pb.

When the laser beam is irradiated on the recording layer 23, the predetermined region of the recording layer 23 on which a laser beam set to have the recording power Pw is irradiated is heated to a melting point or more and is then quenched so that an amorphous region is provided and a recording mark is formed. Thus, data are recorded on the recording layer 23.

In the embodiment, a laser beam having a short wavelength of 380 nm to 450 nm is irradiated through an objective lens having a high numerical aperture NA of 0.7 to 0.9 so that data are recorded. Therefore, the recording layer 23 is locally heated to a very high temperature. Thus, a heat generated on the recording layer 23 is also transferred to the light transmitting layer 13 having a low heat resistance. For this reason, there is a possibility that the light transmitting layer 13 might be heated to a high temperature.

In the embodiment, however, the first dielectric layer 26 functioning as a radiating layer is formed between the recording layer 23 and the light transmitting layer 13. Even if the recording layer 23 is locally heated to a very high temperature, a heat generated on the recording layer 23 can be diffused effectively before the heat is transferred to the light transmitting layer 13. Accordingly, it is possible to prevent the light transmitting layer 13 from being heated to a high temperature. Thus, it is possible to enhance the reliability of the optical recording medium.

In the embodiment, moreover, the third dielectric layer 24 and the fourth dielectric layer 22 which contain zirconium oxide as a main component are formed to interpose the recording layer 23 therebetween. According to the investigations of the inventor, it has been found that a recording mark can be formed to record data on the recording layer 23 as desired in such a case.

There is not always apparent the reason why the recording mark can be formed to record data on the recording layer 23 as desired in the case in which the third dielectric layer 24 and the fourth dielectric layer 22 which contain the zirconium oxide as the main component are formed to interpose the recording layer 23 therebetween. However, it can be guessed that the third dielectric layer 24 and the fourth dielectric layer 22 are formed to contain the zirconium oxide as the main component so that the thermal conductivities of the third dielectric layer 24 and the fourth dielectric layer 22 are increased, and consequently, the heat generated on the recording layer 23 can be diffused effectively to each of the first dielectric layer 26 side and the reflecting layer 21 side, resulting in an increase in a cooling efficiency. While the zirconium oxide has been known as a material having a low thermal conductivity, generally, the zirconium oxide is formed to have a cubic crystallinity in the embodiment. For this reason, it can be supposed that the thermal conductivities of the third dielectric layer 24 and the fourth dielectric layer 22 can be increased.

In the case in which the data recorded on the recording layer 23 are to be rewritten, moreover, a laser beam having a power modulated among the recording power Pw, the erase power Pe and the base power Pb is irradiated on the recording layer 23 in the same manner as in the case in which the data are to be recorded on the recording layer 23.

When the laser beam is irradiated on the recording layer 23, a region on which a laser beam set to have the recording power Pw is irradiated is heated to a melting point or more and is then quenched. Consequently, an amorphous region is formed, and furthermore, a region on which a laser beam set to have the erase power Pe is irradiated is heated to a temperature which is equal to or higher than a crystallizing temperature, and is then cooled slowly and is thus crystallized. The formation of the amorphous region and that of the crystalline region are carried out corresponding to a region in which a recording mark is to be newly formed and a region in which the recording mark is to be erased. Thus, the data recorded on the recording layer 23 are rewritten. A change in the amorphous and crystalline properties of the phase transition material contained in the recording layer 23 is reversible. Therefore, the data recorded on the recording layer 23 can be rewritten repetitively.

When the data recorded on the recording layer 23 are written many times, however, there is a possibility that the crystallizing speed of the recording layer 23 might be reduced and the data recorded on the recording layer 23 might not be rewritten as desired.

In the embodiment, the third dielectric layer 24 and the fourth dielectric layer 22 which are formed in the vicinity of the recording layer 23 contain the zirconium oxide as the main component and do not substantially contain the sulfur. Even if the phase transition material contained in the recording layer 23 is molten many times, therefore, the property of the recording layer 23 can be prevented from being changed by the influence of the elements contained in the third dielectric layer 24 and the fourth dielectric layer 22. Thus, it is possible to reliably prevent the crystallizing speed of the recording layer 23 from being reduced. According to the embodiment, therefore, the data recorded on the recording layer 23 can be rewritten repetitively as desired.

On the other hand, the data recorded on the recording layer 23 are reproduced in the following manner.

In the case in which the data recorded on the recording layer 23 are to be reproduced, a laser beam set to have the reproducing power Pr is focused on the recording layer 23 and is irradiated on the recording layer 23 through the light transmitting layer 13.

The laser beam irradiated on the recording layer 23 is reflected by the recording layer 23 and the reflecting layer 21, and the amount of the light of the laser beam thus reflected is detected so that the data recorded on the recording layer 23 are reproduced.

In the embodiment, the reflecting layer 21 can be formed to contain Ag and to have an excellent flatness on the surface thereof Therefore, it is possible to reduce the noise level of a reproducing signal when the data recorded on the recording layer 23 are to be reproduced. On the other hand, however, Ag has a high reactivity to the sulfur. For this reason, there is a new problem in that Ag contained in the reflecting layer 21 reacts to the sulfur contained in the dielectric layer formed in the vicinity of the reflecting layer 21 and the surface of the reflecting layer 21 is corroded when the dielectric layer containing the sulfur is formed in the vicinity of the reflecting layer 21. In the embodiment, however, the fourth dielectric layer 22 formed between the reflecting layer 21 and the recording layer 23 contains the zirconium oxide as the main component and does not substantially contain the sulfur. Consequently, it is possible to avoid the corrosion of the surface of the reflecting layer 21.

In the embodiment, moreover, the third dielectric layer 24 and the fourth dielectric layer 22 are formed to have a cubic crystallinity and to contain, as a main component, zirconium oxide including a crystal having a crystal grain size of 20 nm or less. According to the investigations of the inventor, it has been found that the third dielectric layer 24 and the fourth dielectric layer 22 can be formed in such a manner that surfaces thereof have a very high flatness in such a case.

According to the embodiment, therefore, both of the surfaces of the third dielectric layer 24 and the fourth dielectric layer 22 have a very high flatness so that a noise level included in a reproducing signal generated when reproducing the data recorded on the recording layer 23 can be reduced still more.

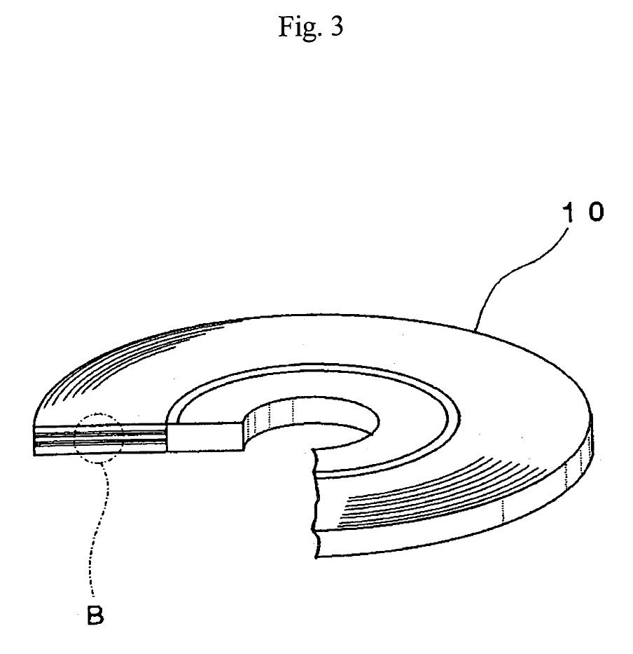

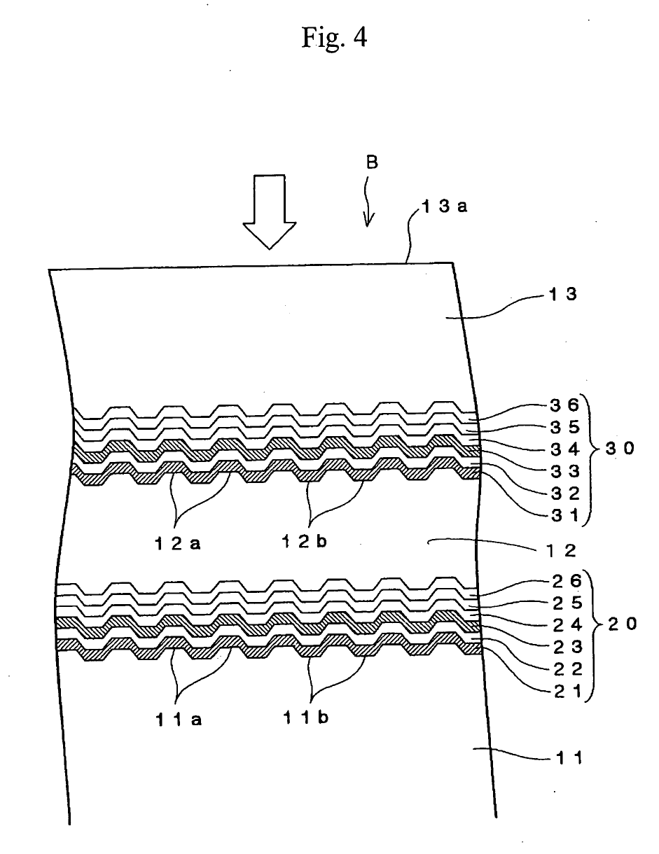

FIG. 3 is a schematic perspective view showing an optical recording medium according to a preferred embodiment of the invention, and FIG. 4 is a schematic enlarged sectional view showing a portion indicated as B in FIG. 3.

As shown in FIG. 4, an optical recording medium 10 according to the embodiment comprises a first information layer 20 formed on a support substrate 11, an intermediate layer 12 formed on the first information layer 20, a second information layer 30 formed on the intermediate layer 12, and a light transmitting layer 13 formed on the second information layer 30.

The first information layer 20 has the same structure as the structure of the information layer 20 shown in FIG. 2.

The intermediate layer 12 has the function of separating the first information layer 20 from the second information layer 30 physically and optically at a sufficient distance.

A groove 12a and a land 12b are alternately formed on the surface of the intermediate layer 12. In the case in which data are to be recorded on the second information layer 30 and the case in which the data are to be reproduced from the second information layer 30, the groove 12a and/or the land 12b which are/is formed on the surface of the intermediate layer 12 function(s) as a guide track for a laser beam. The depth and pitch of the groove 12a formed on the surface of the intermediate layer 12 can be set to be almost equal to the depth and pitch of the groove 11a provided on the surface of the support substrate 11.

The intermediate layer 12 is to have a high light transmittance because the laser beam passes. However, the intermediate layer 12 does not need to be always transparent, and it is sufficient that the intermediate layer 12 has such a sufficient light transmittance as to transmit the amount of a light which is necessary for recording data on the first information layer 20 and reproducing the recorded data.

A material for forming the intermediate layer 12 which has a high light transmittivity to a laser beam is not particularly restricted, and it is preferable that an ultraviolet curing acryl resin should be used in the same manner as in the light transmitting layer 13.

The intermediate layer 12 preferably has a thickness of 10 μm to 40 μm and further preferably has a thickness of 15 μm to 35 μm.

As shown in FIG. 4, the second information layer 30 includes a reflecting layer 31 formed on the intermediate layer 12, a fourth dielectric layer 32 formed on the reflecting layer 31, a recording layer 33 formed on the fourth dielectric layer 32, a third dielectric layer 34 formed on the recording layer 33, a second dielectric layer 35 formed on the third dielectric layer 34, and a first dielectric layer 36 formed on the second dielectric layer 35. The reflecting layer 31, the fourth dielectric layer 32, the recording layer 33, the third dielectric layer 34, the second dielectric layer 35 and the first dielectric layer 36 have the same structures as those of the reflecting layer 21, the fourth dielectric layer 22, the recording layer 23, the third dielectric layer 24, the second dielectric layer 25 and the first dielectric layer 26 in the first information layer 20, respectively.

In the optical recording medium 10 shown in FIG. 4, when data are to be recorded on the first information layer 20 and the recorded data are to be reproduced, a laser beam is irradiated on the first information layer 20 through the second information layer 30. For this reason, the second information layer 30 is to have a high light transmittivity to some extent. Accordingly, it is necessary to form the second information layer 30 in a small thickness. It is necessary to reduce the thicknesses of the reflecting layer 31 and the recording layer 33 which have a low light transmittivity in various layers included in the second information layer 30.

However, the reflecting layer 31 transmits a laser beam, while it plays a part in the reflection of the laser beam when the data recorded on the second information layer are to be reproduced. For this reason, the reflecting layer 31 is to have some reflectance with respect to the laser beam. As compared with the reflecting layer 21 in the first information layer 20, accordingly, the reflecting layer 31 is formed more thinly to have such a thickness as to maintain some reflectance with respect to the laser beam. More specifically, the reflecting layer 31 preferably has a thickness of 3 nm to 20 nm and further preferably has a thickness of 3 nm to 15 nm.

Moreover, the recording layer 33 also transmits a laser beam, while it also functions as a layer on which data are to be recorded. For this reason, it is necessary for the recording layer 33 to have sufficient recording and reproducing characteristics for recording data and reproducing the data thus recorded. As compared with the recording layer 23 in the first information layer 20, accordingly, the recording layer 33 is formed more thinly to have such a thickness as to maintain the sufficient recording and reproducing characteristics for recording data and reproducing the data thus recorded. More specifically, the recording layer 23 preferably has a thickness of 3 nm to 10 nm and further preferably has a thickness of 5 nm to 8 nm.

Data are recorded on the optical recording medium 10 having the above structure in the following manner.

In the embodiment, in order to record the data onto the optical recording medium 10 or to rewrite the data recorded on the optical recording medium 10, a laser beam having a wavelength λ of 380 nm to 450 nm is irradiated on the optical recording medium 10 through an objective lens having a numerical aperture NA of 0.7 to 0.9 and the laser beam is focused on either the first information layer 20 or the second information layer 30.

In the case in which data are to be recorded on the second information layer 30 or data recorded on the second information layer 30 are to be rewritten, a laser beam having a power modulated among a recording power Pw, an erase power Pe and a base power Pb is focused on the recording layer 33 in the second information layer 30 and is irradiated on the recording layer 33 through the light transmitting layer 13.

When the laser beam is irradiated on the recording layer 33, an amorphous region and a crystalline region are formed so that data are recorded on the recording layer 33 or data recorded on the recording layer 33 are rewritten.

As compared with the recording layer 23 in the first information layer 20, the recording layer 33 is formed more thinly. When the dielectric layer containing the sulfur is formed in the vicinity of the recording layer 33, therefore, the recording layer 33 is easily influenced by the sulfur contained in the dielectric layer. In the embodiment, however, the third dielectric layer 34 and the fourth dielectric layer 32 which are formed in the vicinity of the recording layer 33 contain zirconium oxide as a main component and do not substantially contain the sulfur. Even if a phase transition material contained in the recording layer 33 is molten many times, therefore, the property of the recording layer 33 can be prevented from being changed by the influence of elements contained in the third dielectric layer 34 and the fourth dielectric layer 32. Consequently, it is possible to reliably prevent the crystallizing speed of the recording layer 33 from being reduced. According to the embodiment, therefore, even if the recording layer 33 is formed thinly, the data recorded on the recording layer 33 can be rewritten repetitively as desired.

In the embodiment, moreover, the third dielectric layer 34 and the fourth dielectric layer 32 which contain the zirconium oxide as the main component are formed to interpose the recording layer 33 therebetween. In such a case, a heat generated on the recording layer 33 can be diffused effectively so that the cooling efficiency of the second information layer 30 can be enhanced. Thus, the second information layer 30 has an excellent radiating property. Even if the reflecting layer 31 is formed thinly, therefore, the recording layer 33 can be cooled quickly corresponding to the switching of the power of the laser beam from the recording power Pw to the base power Pb, and a recording mark can be formed to record data on the recording layer 33 as desired.

In the case in which data are to be recorded on the first information layer 20 or data recorded on the first information layer 20 are to be rewritten, moreover, a laser beam having a power modulated among the recording power Pw, the erase power Pe and the base power Pb is focused on the recording layer 23 in the first information layer and is irradiated on the recording layer 23 through the light transmitting layer 13 and the second information layer 30.

In the embodiment, the recording layer 33 and the reflecting layer 31 can be formed thinly. Therefore, it is possible to enhance the light transmittivity of the second information layer 30. When a laser beam is transmitted through the second information layer 30, accordingly, a decrease in the amount of the light of the laser beam can be minimized and data can be recorded on the first information layer 20 as desired.

On the other hand, the data recorded on the first information layer 20 are reproduced in the following manner.

In the case in which the data recorded on the recording layer 23 in the first information layer 20 are to be reproduced, a laser beam set to have a reproducing power Pr is focused on the first information layer 20 and is irradiated on the first information layer 20 through the light transmitting layer 13.

The laser beam irradiated on the first information layer 20 is reflected by the recording layer 23 and the reflecting layer 21, and the amount of the light of the laser beam thus reflected is detected so that the data recorded on the first information layer 20 are reproduced.

In the embodiment, the light transmittivity of the second information layer 30 can be enhanced. Therefore, it is possible to minimize the decrease in the amount of the light of the laser beam when the laser beam is transmitted through the second information layer 30 and when the laser beam reflected by the recording layer 23 and the reflecting layer 21 is transmitted through the second information layer 30. Thus, the data recorded on the first information layer 20 can be reproduced as desired.

The invention is not restricted to the above embodiments and examples but various changes can be made within the scope of the invention described in the appended claims, and it is apparent that they are also included in the scope of the invention.

For example, while the third dielectric layers 24 and 34 and the fourth dielectric layers 22 and 32 in the optical recording media 1 and 10 contain the zirconium oxide as the main component in the embodiments shown in FIGS. 1 to 4, the invention is not restricted thereto. More specifically, it is sufficient that the third dielectric layers 24 and 34 and the fourth dielectric layers 22 and 32 include, as the main component, an oxide containing at least one of metals of Zr and Mg, and may include, as the main component, an oxide containing Mg or an oxide containing Zr and Mg in place of the zirconium oxide. The oxide containing Mg has a high thermal conductivity even if it does not have a cubic crystalline structure. In the case in which the third dielectric layers 24 and 34 and the fourth dielectric layers 22 and 32 include, as the main component, the oxide containing Mg, therefore, the oxide containing Mg does not need to have the cubic crystalline structure.

While all of the third dielectric layers 24 and 34 and the fourth dielectric layers 22 and 32 in the optical recording media 1 and 10 are formed to contain the zirconium oxide as the main component in the embodiments shown in FIGS. 1 to 4, moreover, the invention is not restricted thereto but it is sufficient that at least the third dielectric layers 24 and 34 are formed to contain the zirconium oxide as the main component.

While the optical recording medium 10 comprises the support substrate 11, the first information layer 20, the intermediate layer 12, the second information layer 30 and the light transmitting layer 13, and both the first information layer 20 and the second information layer 30 include the first dielectric layer having a higher thermal conductivity than the second dielectric layer, the second dielectric layer having a lower hardness than the first dielectric layer and the third dielectric layer, and the third dielectric layer including, as a main component, a dielectric material which does not substantially contain sulfur in the embodiment shown in FIG. 4, moreover, the invention is not restricted thereto but it is sufficient that at least one of the first information layer 20 and the second information layer 30 includes the first dielectric layer having a higher thermal conductivity than the second dielectric layer, the second dielectric layer having a lower hardness than the first dielectric layer and the third dielectric layer, and the third dielectric layer including, as a main component, a dielectric material which does not substantially contain sulfur.

While the optical recording medium 10 is provided with two information layers in the embodiment shown in FIG. 4, moreover, the invention is not restricted to the optical recording medium having two information layers but can be applied to an optical recording medium having at least two information layers.

While the optical recording media 1 and 10 comprise the light transmitting layer 13 in the embodiments shown in FIGS. 1 to 4, furthermore, a hard coating layer containing a hard coating composition as a main component may be provided in place of the light transmitting layer 13 or on the surface of the light transmitting layer 13, and furthermore, the hard coating layer may be caused to contain a lubricant in order to give the function of a lubricity or an antifouling property or a lubricating layer containing a lubricant as a main component may be provided separately on the surface of the hard coating layer.

This application is based upon and claims the benefit of priority of Japanese Patent Application No. 2004-12845 filed on Jan. 20, 2004, the contents of which are incorporated herein by reference in its entirety.

1. An optical recording medium comprising:
a substrate;
a recording layer, formed on the substrate, including a phase transition material;
a light transmitting layer formed on the recording layer, through which a laser beam is irradiated on the recording layer to record and erase data; and
at least three dielectric layers containing, as main components, different dielectric materials from each other, formed between the recording layer and the light transmitting layer.

2. The optical recording medium according to claim 1, wherein a first dielectric layer, a second dielectric layer and a third dielectric layer are provided in order from an incidence plane side for a laser beam between the recording layer and the light transmitting layer,
the first dielectric layer has a higher thermal conductivity than the second dielectric layer,
the second dielectric layer has a lower hardness than the first dielectric layer and the third dielectric layer, and
the third dielectric layer includes, as a main component, a dielectric material which does not substantially contain sulfur.

3. An optical recording medium comprising;
a substrate;
a plurality of recording layers, formed on the substrate, including a phase transition material and provided through at least an intermediate layer;
a light transmitting layer formed on one of the recording layers, through which a laser beam is irradiated on the recording layers to record and erase data; and
at least three dielectric layers containing, as main components, different dielectric materials from each other are formed between at least one of the recording layers and the light transmitting layer or between at least one of the recording layers and the intermediate layer.

4. The optical recording medium according to claim 3, wherein a first dielectric layer, a second dielectric layer and a third dielectric layer are provided in order from an incidence plane side for the laser beam between at least one of the recording layers and the light transmitting layer or between at least one of the recording layers and the intermediate layer,
the first dielectric layer has a higher thermal conductivity than the second dielectric layer,
the second dielectric layer has a lower hardness than the first dielectric layer and the third dielectric layer, and
the third dielectric layer includes, as a main component, a dielectric material which does not substantially contain sulfur.

5. The optical recording medium according to claim 2 or 4, wherein the first dielectric layer includes, as a main component, a nitride or an oxide containing an element selected from the group consisting of B, Al, Ga, In, C, Si, Ge, Be, Zn and Sn or their mixture.

6. The optical recording medium according to claim 2 or 4, wherein the third dielectric layer includes, as a main component, an oxide containing at least one of metals of Zr and Mg.

7. The optical recording medium according to any of claims 1 to 4, further comprising a reflecting layer, and a dielectric layer including, as a main component, an oxide containing at least one of metals of Zr and Mg being further formed between the recording layer and the reflecting layer.

8. The optical recording medium according to claim 7, wherein the reflecting layer contains a metal as a main component.

9. The optical recording medium according to any of claims 1 to 4, wherein a laser beam having a wavelength λ of 380 nm to 450 nm is irradiated through an objective lens having a numerical aperture NA of 0.7 to 0.9 so that data can be recorded and recorded data can be erased.
